(19) United States
(12) Patent Application Publication
(10) Pub. No.: US 2022/0297477 A1
(43) Pub. Date: Sep. 22, 2022

(54) Body Ply Skim Layer

(71) Applicant: Bridgestone Europe NV/SA [BE/BE], Zaventem (BE)

(72) Inventors: Paolo Fiorenza, Roma (IT); Giacomo Andreini, Roma (IT)

(21) Appl. No.: 17/619,053

(22) PCT Filed: Jun. 24, 2020
(86) PCT No.: PCT/IB2020/055978

§ 371 Date: Dec. 14, 2021

(30) Foreign Application Priority Data
Jun. 28, 2019 (IT) 102019000010449

(51) Int. Cl. B60C 5/14; B60C 9/04; B60C 1/00

(52) U.S. Cl. CPC B60C 5/14; B60C 9/04; B60C 1/0008; B60C 2005/145; B60C 2009/0284

(57) ABSTRACT

A body ply skim layer in which a reinforcing ply is embedded, arranged at a distance T from an outer surface of the body ply skim layer and at a distance B from an inner surface of the body ply skim layer, such as to define an asymmetry index AT equal to 100×(T−B/T+B). The asymmetry index AT is greater than −100 and less than 0.

The present invention relates to a Body Ply Skim layer having characteristics such as to allow for a drastic reduction in the thickness of the innerliner layer, if not its complete elimination.

The innerliner is an inner rubber layer that, insofar as it is substantially impermeable to air, is used in tubeless pneumatic tires in order to maintain under pressure the air within the inner cavity of the pneumatic tire. Moreover, the innerliner must ensure that oxygen remains as much as possible confined within the inner cavity and does not spread within those compounds that constitute the other parts of the pneumatic tire, thereby leading to degradation phenomena.

In the manufacture of pneumatic tires, in order to ensure the required standards of strength and durability, reinforcing plies are used that are made from a thermoplastic material (e.g. nylon, rayon, polyester, aramid, PET). The rubber layer arranged such as to encompass the plies is indicated with the English wording “body ply skim” and is, generally, in direct contact with the innerliner layer.

As is known, within the pneumatic tire industry there is a need to reduce the weight of the pneumatic tire with positive repercussions in terms of the overall energy consumption of the vehicle and the rolling resistance of the same.

As may be immediately obvious to a person skilled in the art, a reduced thickness of the innerliner layer or, indeed, its elimination, necessarily translates into a lower quantity of material used, with the obvious advantages that this entails both in terms of productivity and in terms of lower weight for the pneumatic tire itself, with positive effects upon the overall energy consumption of the vehicle and upon the rolling resistance.

One of the problems that may arise once the innerliner layer is thinned, if not indeed eliminated, concerns the possible exposure of the cords that constitute the reinforcing ply. In fact, as is known, during the vulcanization step the green pneumatic tire is compressed between the walls of the mold by virtue of the action of a bladder that, in swelling, pushes the pneumatic tire from within against the walls of the mold. During this step of vulcanizing the rubber layers, such as the innerliner, where present, and the body ply skim, in which the reinforcing plies are incorporated, are compressed under the action of the bladder, and the cords of the reinforcing plies necessarily approach the inner surface of the pneumatic tire that defines the internal cavity of the pneumatic tire.

From the above description it is immediately clear that if the innerliner is very thin or absent, the cords may either produce protuberances upon the inner surface of the pneumatic tire, or, indeed, even emerge from the rubber layer and thus be exposed. As may be immediately apparent to a person skilled in the art, such possibilities necessarily lead to critical pneumatic tire issues that compromise its operation.

The object of the present invention is to implement a solution that is capable of preventing the protrusion or emerging of the cords, where a very thin innerliner layer is used or where the innerliner layer is not used.

The inventors of the present invention have made a body ply skim layer in which the technical characteristics are such as to allow for severe thinning of the innerliner layer, or its complete removal, without the occurrence of the phenomena mentioned above.

The subject matter of the present invention is a pneumatic tire comprising a body ply skim layer made with a single rubber compound and in which a reinforcing ply is embedded; said reinforcing body ply being arranged at a distance T from an outer surface of the body ply skim layer and at a distance B from an inner surface of the body ply skim layer such as to define an asymmetry index AI equal to 100×(T−B/T+B); said outer surface being directed towards a tread of the pneumatic tire and said inner surface being directed towards an inner cavity of the pneumatic tire; said pneumatic tire being characterized in that said asymmetry index AI is greater than −100 and less than 0.

By outer surface of the body ply skim is meant the surface of the body ply skim facing the tread of the pneumatic tire; by inner surface of the body ply skim is meant the surface of the body ply skim directed towards the inner cavity of the pneumatic tire.

Preferably, said asymmetry index AI is greater than −85 and less than −30.

Preferably, the body ply skim layer has a thickness of between 0.9 and 2.0 mm.

Preferably, said body ply skim layer is made with a compound comprising polyepihalohydrin rubber; epoxidized natural rubber as a cross-linkable unsaturated chain polymer base; a filler and a vulcanization system.

Here and hereinafter, by vulcanization system is meant a complex of ingredients comprising at least sulfur and accelerating compounds, which in the preparation of the compound are added in a final mixing step and have the purpose of promoting the vulcanization of the polymer base once the compound is subjected to a vulcanization temperature.

Here and hereinafter, the term “cross-linkable unsaturated chain polymer base” refers to any natural or synthetic non-cross-linked polymer capable of assuming all of the chemical-physical and mechanical characteristics typically assumed by elastomers upon cross-linking (vulcanization) with sulfur-based systems.

Preferably, the said filler is a material with a lamellar structure.

Preferably, the compound comprises: from 70 to 90 phr of said polyepihalohydrin rubber; from 5 to 25 of said epoxidized natural rubber (E-NR); and from 5 to 25 of natural rubber (NR); the ratio in phr between the E-NR and NR being between 0.2 and 5.0.

The quantities are expressed in phr, i.e., in parts per 100 parts of rubber, wherein rubber refers to the complex consisting of polyepihalohydrin, E-NR and NR.

Preferably, the ratio in phr between E-NR and NR being between 1.0 and 3.0.

Preferably, the polyepihalohydrin rubber is a rubber deriving from the epichlorohydrin homopolymer or from the epichlorohydrin/allyl-glycidyl ether copolymer or from the epichlorohydrin/ethylene oxide copolymer or from the epichlorohydrin/ethylene oxide/allyl-glycidyl ether terpolymer.

For a better understanding of the invention, the following examples serve for illustrative and non-limiting purpose with the help of the attached figures, wherein:

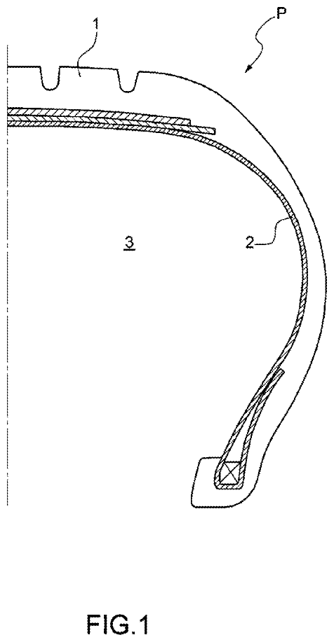

FIG. 1 is a sectional view of a portion of a pneumatic tire according to the invention;

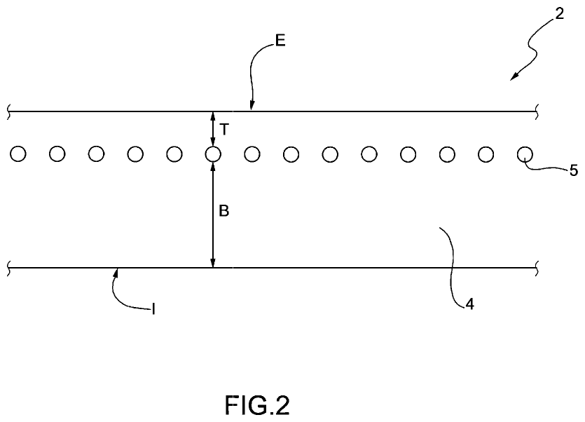

FIG. 2 is a section of a portion of body ply skim layer according to the invention.

In FIG. 1 there is indicated, in its entirety with P, a pneumatic tire according to the present invention.

The pneumatic tire P comprises a tread layer 1 and a body ply skim layer 2 that faces directly an inner cavity 3 of the pneumatic tire P.

In particular, in the pneumatic tire P, the body ply skim layer 2 faces directly the inner cavity 3 insofar as the presence of the innerliner layer is not envisaged.

In FIG. 2 there is indicated, in its entirety with 2, a body ply skim layer according to the present invention. The body ply skim layer consists of a single compound 4 and a reinforcing ply 5 accommodated within the single compound 4.

The body ply skim layer 2 comprises an outer surface E directed towards a tread 1 of the pneumatic tire, and an inner surface I facing the inner cavity 3.

In FIG. 2 there is indicated with T the distance between the cord 5 and the outer surface E, and with B the distance between the cord 5 and the inner surface I.

### EXAMPLES

Three pneumatic tire were manufactured: the pneumatic tire A represents a comparative example and comprises a body ply skim layer with a thickness equal to 1.2 mm in which a reinforcing ply of PET is embedded, having an AI equal to 0, and an innerliner layer with a thickness equal to 1.0 mm; the pneumatic tire B represents a comparative example and comprises a body ply skim layer with a thickness equal to 1.2 mm in which a reinforcing ply of PET is embedded, having an AI equal to 0, and does not comprise any innerliner layer; the pneumatic tire C represents an example according to the invention and comprises a body ply skim layer with a thickness equal to 1.2 mm in which a reinforcing ply of PET is embedded, having an AI equal to −49, and does not comprise any innerliner layer.

The pneumatic tires A-C are the same in all respects except for the presence of the innerliner layer and the position of the PET reinforcing ply.

The body ply skim layer was manufactured using a compound which composition in phr is reported in Table I

TABLE I

| | A |
|---|---|
| NR | 15.0 |
| E-NR | 15.0 |
| Polyepihalohydrin rubber | 70.0 |
| CB | 40.0 |
| Sulfur | 2.0 |
| MBTS | 0.2 |
| TBBS | 0.8 |

NR stands for natural rubber that is made of a polymer base composed of natural origin cis-1,4-polyisoprene.

E-NR stands for epoxidized natural rubber, presenting a degree of epoxidation of 25%.

The polyepihalohydrin rubber used is a rubber derived from the epichlorohydrin/ethylene oxide/allyl-glycidyl ether terpolymer marketed as T3000 by the company ZEON.

CB stands for carbon black belonging to the class N6.

MBTS is the acronym for mercaptobenzothiazole disulfide used as a vulcanization accelerant.

TBBS is the acronym for N-tert-butyl-2-benzothiazole sulfenamide used as a vulcanization accelerant.

Preparation of the Compound

The compound was made according to the standard procedure described below, which is not relevant to the purposes of the present invention.

(1^{st} mixing step)

Before the start of the mixing, a mixer with tangential rotors (commonly called a Banbury) and an internal volume of between 230 and 270 liters was loaded with the polymer bases and the reinforcing filler, reaching a fill factor of between 66-72%.

The mixer was operated at a speed of between 40-60 revolutions/minute, and the mixture thus formed was discharged once a temperature of between 140-160° C. had been reached.

(2^{nd} mixing step)

The vulcanization system was added to the mixture obtained from the previous step, reaching a fill factor of between 63-67%.

The mixer was operated at a speed of between 20-40 revolutions/minute, and the mixture thus formed was discharged once a temperature of between 100-110° C. had been reached.

The pneumatic tires A-C were manufactured by means of an equal vulcanization process.

Once manufactured, the pneumatic tires were evaluated in terms of the weight of the innerliner+body ply skim (I+BPS) assembly, rolling resistance and Appearance.

Table II lists the assessments of the parameters described above.

The Appearance assessments derive from tactile and visual inspections on the part of an operator in the industry.

The data in relation to the weight are expressed in terms of variation of the weight of the I+BPS assembly of the pneumatic tire A.

The rolling resistance values are indexed with respect to the relative value of the pneumatic tire A and were detected in accordance with ISO28580 procedure

TABLE II

| | Pneumatic tire | Pneumatic tire | Pneumatic tire |
|---|---|---|---|
| | A | B | C |
| Weight Variation | 0 | −495.0 | −495.0 |
| I + BPS (g) | | | |
| Rolling | 100 | 98 | 98 |
| resistance* | | | |
| Appearance | PROTRUBERANCES | PROTRUBERANCES | PROTRUBERANCES |
| | NO | YES | NO |

As is clear from the assessments of Table II, the solution, which is the subject matter of the present invention, offers the great advantage of being able to eliminate the innerliner layer, with the relative advantages in terms of weight and rolling resistance, without thereby provoking the exposure or emergence of the cords of the reinforcing ply. Furthermore, it is important to emphasize that the compound used also ensures the necessary impermeability to air, notwithstanding the lack of an innerliner.

1-9. (canceled)

10. A pneumatic tire comprising:
a body ply skim layer comprising a single rubber compound and in which a reinforcing ply is embedded;
wherein said reinforcing ply is arranged at a first distance (T) from an outer surface of the body ply skim layer and at a second distance (B) from an inner surface of the body ply skim layer such as to define an asymmetry index equal to 100×[(T−B)/(T+B)];
wherein said outer surface is directed towards a tread of the pneumatic tire and said inner surface is directed towards an inner cavity of the pneumatic tire; and
wherein said asymmetry index is greater than −100 and less than 0.

11. The pneumatic tire of claim 10, wherein said asymmetry index is greater than −85 and less than −30.

12. The pneumatic tire of claim 10, wherein the body ply skim layer has a thickness of between 0.9 and 2.0 millimeters (mm).

13. The pneumatic tire of claim 10, wherein said body ply skim layer is made with a compound comprising polyepihalohydrin rubber; epoxidized natural rubber as a cross-linkable unsaturated chain polymer base; a filler; and a vulcanization system.

14. The pneumatic tire of claim 13, wherein said filler is a material with a lamellar structure.

15. The pneumatic tire of claim 13, wherein the compound comprises: from 70 to 90 parts per hundred parts of rubber (phr) of said polyepihalohydrin rubber; from 5 to 25 phr of said epoxidized natural rubber (E-NR); and from 5 to 25 phr of natural rubber (NR).

16. The pneumatic tire of claim 15, wherein the ratio in phr between E-NR and NR is between 0.2 and 5.0.

17. The pneumatic tire of claim 16, wherein the ratio in phr between E-NR and NR is between 1.0 and 3.0.

18. The pneumatic tire of claim 13, wherein the polyepihalohydrin rubber is a rubber deriving from the epichlorohydrin homopolymer.

19. The pneumatic tire of claim 13, wherein the polyepihalohydrin rubber is a rubber deriving from the epichlorohydrin/allyl-glycidyl ether copolymer.

20. The pneumatic tire of claim 13, wherein the polyepihalohydrin rubber is a rubber deriving from the epichlorohydrin/ethylene oxide copolymer.

21. The pneumatic tire of claim 13, wherein the polyepihalohydrin rubber is a rubber deriving from the epichlorohydrin/ethylene oxide/allyl-glycidyl ether terpolymer.

22. The pneumatic tire of claim 10, wherein:
said body ply skim layer directly faces said inner cavity;
said pneumatic tire being free of an innerliner layer.
